(19) United States
(12) Patent Application Publication
(10) Pub. No.: US 2005/0055259 A1
(43) Pub. Date: Mar. 10, 2005

(54) Instruction system and method for equipment problem solving

(76) Inventors: Wen-Chang Kuo, Hsin-Chu (TW); Tien-Der Chiang, Da-Li City (TW); Chien-Chung Huang, Hsin-Chu City (TW); Chun-Yi Chen, Hualien County (TW)

Correspondence Address: DUANE MORRIS, LLP;IP DEPARTMENT, ONE LIBERTY PLACE, PHILADELPHIA, PA, 19103-7396, US

(21) Appl. No.: 10/660,287

(22) Filed: Sep. 10, 2003

(51) Int. Cl. G06F 17/60

(52) U.S. Cl. 705/8

(57) ABSTRACT

A method and system of providing instructions in addressing an equipment problem are provided. An indication of an equipment problem is checked against a solution database to identify at least one suggested solution to the equipment problem. A suggested solution from the at least one suggested solution is provided. An actual fix solution implemented in association with the equipment problem is recorded.

### FIELD OF THE INVENTION

The present invention relates to systems and methods for servicing machinery.

### BACKGROUND OF THE INVENTION

Equipment performance is a major factor in the productivity of manufacturing lines, particularly in expensive, high-output processes utilized in industries such as the semiconductor fabrication industry. Any equipment downtime can lead to significant expense.

Presently, processes for addressing equipment problems that occur in manufacturing facilities tend to be inefficient, particularly in cleanroom environments where resources such as space and computers are limited. Engineers are alerted to an equipment problem, but must rely on personal experience or “trial and error” techniques to identify and implement a solution.

Therefore, a new method and system of implementing solutions to equipment problems in a manufacturing system are desired.

### SUMMARY OF THE INVENTION

A method and system of providing instructions in addressing an equipment problem are provided. An indication of an equipment problem is checked against a solution database to identify at least one suggested solution to the equipment problem. A suggested solution from the at least one suggested solution is provided. An actual fix solution implemented in association with the equipment problem is recorded.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a block diagram of a manufacturing system according to the present invention;

FIG. 2 is a flow diagram illustrating the operation of the system of FIG. 1;

FIG. 3 is an organizational diagram illustrating the derivation of a solution to an equipment problem;

FIG. 4 illustrates an exemplary method of determining the efficiency of a previous equipment problem solution upon reoccurrence of the problem; and

FIG. 5 illustrates and exemplary method of determining the efficiency of a solution identified from a solution database.

### DETAILED DESCRIPTION

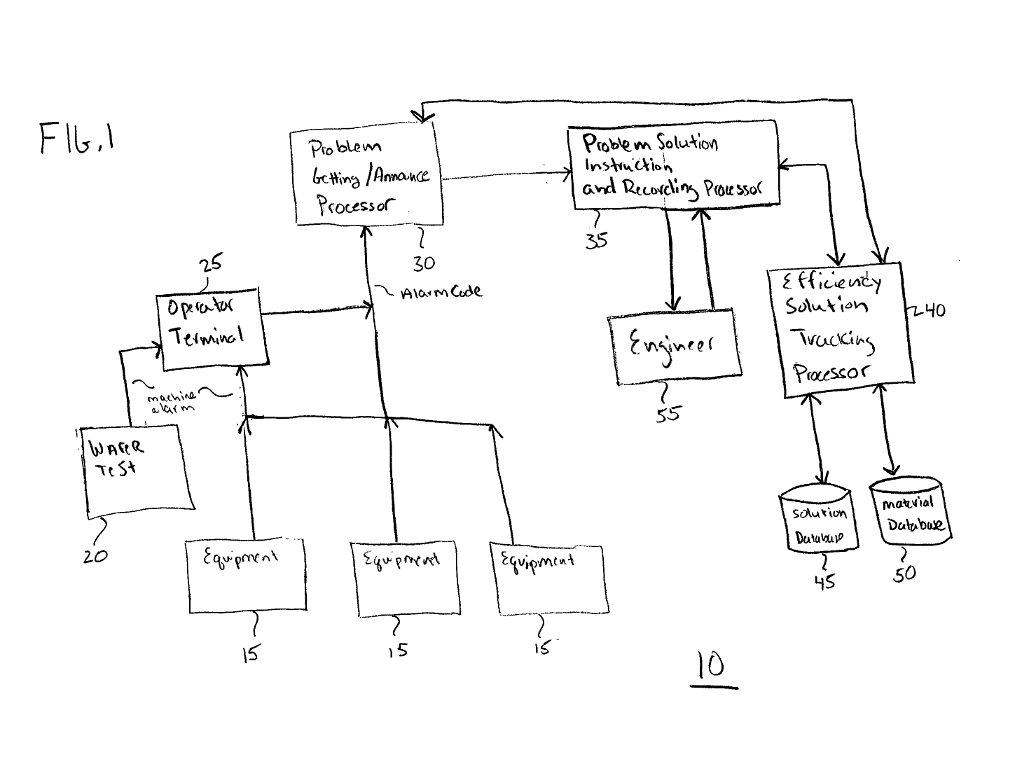

FIG. 1 is a block diagram of a manufacturing system 10. In an exemplary embodiment, the manufacturing system is semiconductor fabrication system for manufacturing integrated circuits on semiconductor wafers. One familiar with such systems will recognize that they rely upon many different pieces of equipment in the fabrication process, including lithography machines, deposition machines, etch chambers, etc., each of which can malfunction at some point (hereinafter, referred to as an “equipment problem”). The system and method described herein, however, apply to other manufacturing and non-manufacturing systems that utilize equipment subject to malfunction.

As illustrated in FIG. 1, system 10 includes at least one, and more commonly a plurality, of pieces of equipment 15 for use in a manufacturing process. In the event that an equipment problem occurs at a specific piece of equipment, that piece of Equipment 15 provides an alarm code to Problem Getting/Announce Processor 30. In a semiconductor fabrication system, Processor 30 communicates with Equipment 15 via the SECS (Semiconductor Equipment Communication Standard) protocol. Alternatively, or additionally, an operator can observe a machine alarm displayed or otherwise indicated on or by a piece of Equipment 15. The operator then registers the machine alarm with an operator terminal 25, e.g., a stand alone computer on the fabrication floor, which communicates an alarm code to the Problem Getting/Announce Processor 30. In a third option, a wafer test 20 is run by the operator on a sample wafer operated upon by a piece of Equipment 15. If a defect is observed or detected in the wafer, the defect is associated by the operator with a specific equipment problem. As described above, the operator then registers the problem with an operator terminal 25, which communicates an alarm code to the Problem Getting/Announce Processor 30.

The Problem Getting/Announce Processor 30 checks the received alarm code against a dataset of equipment problems. Once the equipment problem is identified, the equipment problem is reported to Problem Solution Instruction and Recording (PSIR) Processor 35.

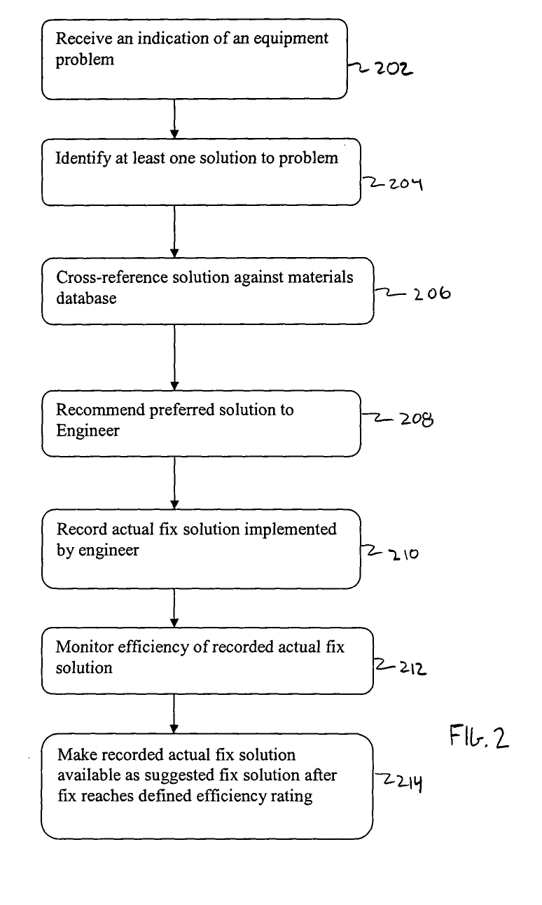

The PSIR Processor 35 is responsible for identifying at least one solution to the equipment problem, as described in more details below in connection with FIG. 2. At least one solution is reported to an Equipment Engineer 55, who then operates on the malfunctioning piece of equipment 15 to implement the solution. It is contemplated that PSIR Processor 35 can communicate with the Engineer 55 in several different manners, including telephone, email, text messaging, instant message, pager or other form of communication. The Engineer can simply be alerted by pager, for example, to check an email message including the text of the solution provided by the PSIR Processor 35. In an exemplary embodiment, the Engineer is equipped with a wireless device, such as a PDA, notebook computer, etc., for receiving messages transmitted from PSIR Processor 35 via wireless hub to provide instructions in real time to the Engineer, e.g., at a time substantially when the equipment problem is detected and a solution is identified.

Although described in connection with providing solutions to engineers for implementation, it is contemplated that implementation of solutions may also be automated, e.g., by machines configured to implement fixes to equipment problems.

In an exemplary embodiment PSIR Processor 35 also preferably provides the Engineer 55 with a list of materials (e.g., machine parts, installation equipment, or other materials) needed to implement the provided solution and an indication of the availability of the materials.

As is also described in more detail below, the PSIR Processor 35 also communicates with Efficiency Solution Tracking (EST) Processor 40, which is in communication with a material database 50 and a solution database 45. The material database includes a listing of materials for implementation of equipment problem solutions and an indication of their respective availability, e.g., “in stock”, “on order”, etc. The solution database 45 includes solutions (e.g., instructions sets) on addressing various equipment problems. One or more solutions can be associated with each anticipated equipment problem. As described in more detail below, EST Processor 40 manages solution database 45 and tracks the efficiency of each solution.

Material database 50 and solution database 45, although shown as two databases, may be implemented in a single database or distributed throughout several databases. The icons illustrated in FIG. 1 merely indicated that one or more data storage units is provided for storing material and solution data.

Referring now to FIG. 2, an exemplary method of instructing an equipment engineer in addressing an equipment problem is detailed. At step 202, an indication of an equipment problem is received by the system 10 at PSIR Processor 35. As detailed above, the Problem Getting/Announce Processor 30 reports an equipment problem to the PSIR Processor 35. Problem Getting/Announce Processor 30 receives an indication of an equipment problem either directly from Equipment 15 or from an Operator Terminal 25.

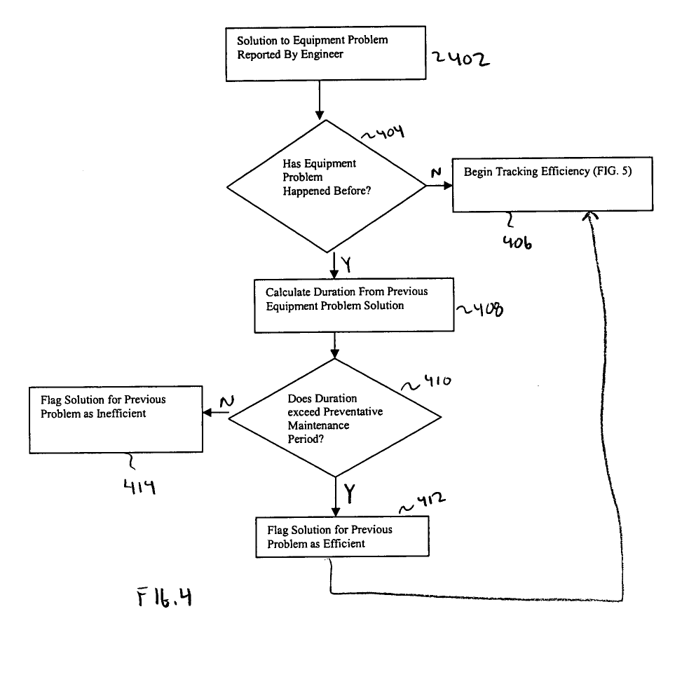

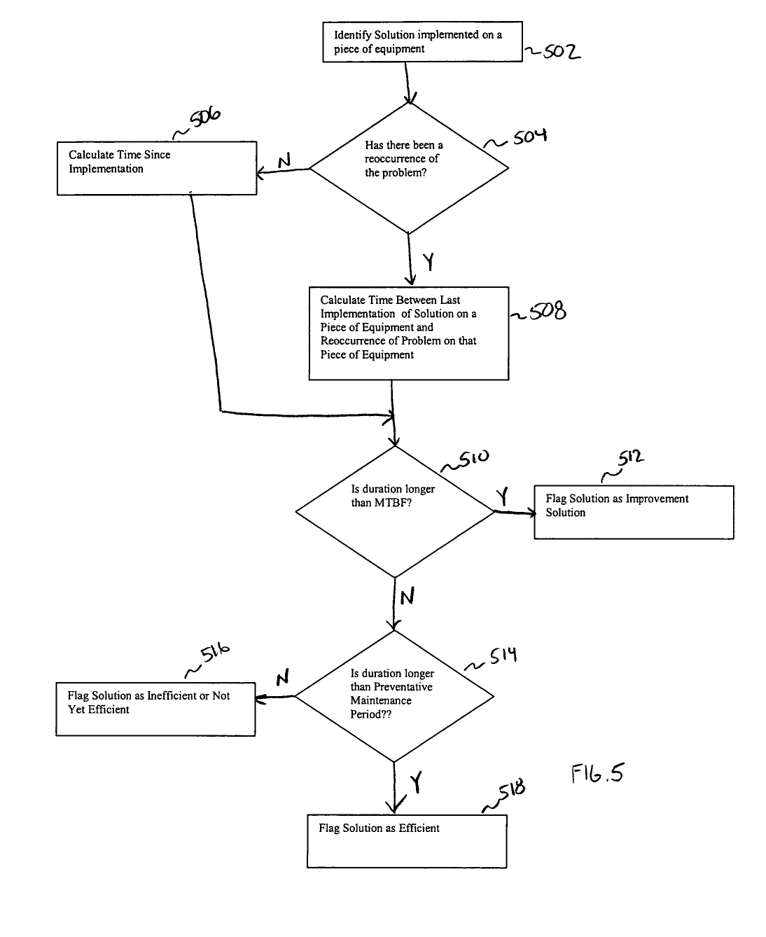

At step 204, at least one solution to the reported equipment problem is identified. In an exemplary embodiment, the at least one solution is identified as follows. PSIR Processor 35 reports the reported problem to EST Processor 40, which checks the problem against solution database 45 to identify suggested solutions. It is recognized that more than one solution to any given equipment problem may be registered in solution database 45. Preferably, each solution in the solution database 45 is also assigned or otherwise associated with an efficiency rating indicating the relative effectiveness of the solution and to enable the system 10 to identify preferred solutions. Derivation of the efficiency of a solution is outlined in more detail below in connection with FIGS. 4-5.

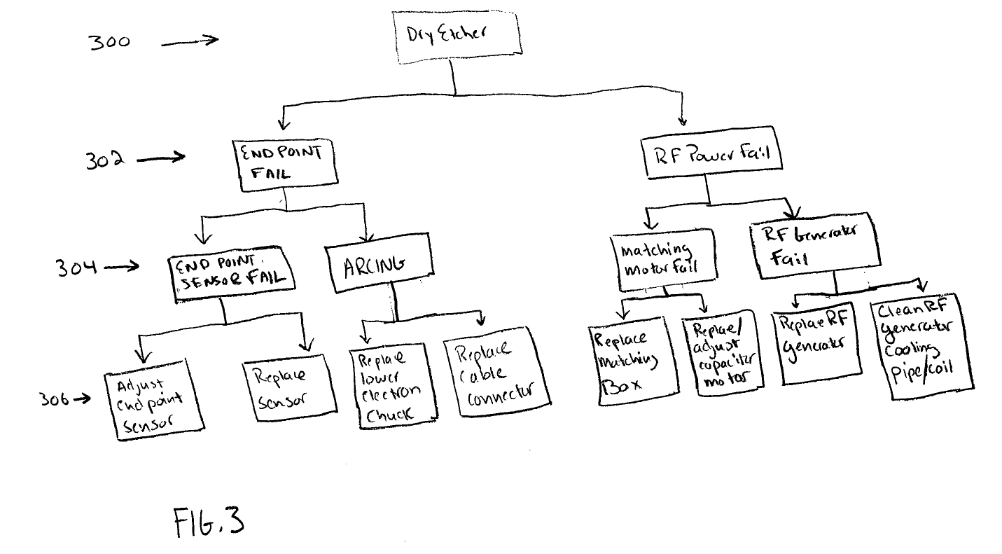

FIG. 3 is an organizational chart indicating how a solution can be identified from solution database 45 as a potential solution to a reported problem. A piece of equipment is indicated at level 300. It should be understood that a plurality of different pieces of equipment are registered in database 45, each having a solution tree as shown in FIG. 3. Level 302 indicates two possible equipment problems that may be encountered with the equipment of level 300. Each problem at 302 can be associated with one or more causes 304. Each cause 304 can be associated with one or more solutions 306. Each solutions 306 is associated with an instruction set and material set (not shown). A hierarchy tree as shown in FIG. 3 can be used by EST Processor 40 to identify all possible solutions 306 to a problem 302 with equipment 300.

At step 206, the identified solutions associated with the reported equipment problem are preferably checked against the material database 50. As mentioned, each solution is associated with a list of materials needed to implement the solution to address the equipment problem. Material database 50 is preferably implemented as a periodically updated inventory database that identifies the availability of the various materials needed for the solutions registered in solution database 45.

In an exemplary embodiment, the EST Processor 40 preferably recommends one or more identified solutions to PSIR Processor 35 as preferred solutions. Assume for example that solution database 45 includes five different suggested solutions to a reported equipment problem, each solution being associated with various materials and an efficiency rating. The EST Processor 35 is configured to recommend a solution or solutions based on some predefined criteria. For example, EST Processor 35 may be programmed to only report to PSIR Processor 35 the two solutions from the group of five solutions that have the highest efficiency rating. An additional criteria may be the availability of materials for implementing the solution, e.g., EST Processor 35 can be configured to recommend only solutions for which necessary materials are available, as indicated in materials database 50. Of course, other criteria can be utilized, and the embodiments just described are provided by way of example and not limitation.

After EST Processor 40 provides the one or more recommended solutions from the suggested solutions to PSIR Processor 35 along with a listing of materials necessary for each solution and the availability of those materials, PSIR Processor 35 reports the equipment problem 35 to the Engineer 55 along with the details of the one or more preferred or recommended solutions, i.e., the instruction set(s) (step 208). The list of materials and their respective availability are also provided to the Engineer 55. In an alternative embodiment, EST Processor 40 reports all solutions to PSIR Processor 35 along with an indication as to the recommended solution(s). In that alternative embodiment, the PSIR Processor 35 then reports all solutions to the Engineer with an indication of the preferred solution(s).

The Engineer 55 then selects a solution from the one or more provided by the PSIR Processor 35. The Engineer then uses the selected solution (e.g., instruction set) to implement a fix at or to the equipment 15 associated with the equipment problem. Alternatively, the Engineer 55 can elect to reject the suggested solution and query the PSIR Processor 35 for alternative solutions. In that case, the PSIR Processor 35 queries EST Processor 40 for additional available solutions, which are then reported to the Engineer 55 by the PSIR Processor 35. In another alternative, the Engineer 55, based on his or her experience, rejects all solution(s) provided to the Engineer from PSIR Processor 35. In that case, the Engineer 55 implements his or her own solution to the equipment problem.

Regardless of whether the Engineer 55 implements his or her own solution or a solution recommended or provided by PSIR Processor 35, the Engineer 55 preferably provides an indication of the actual fix implemented by the Engineer to PSIR processor 35 for recordation. At least three possible scenarios are contemplated. In a first scenario, the Engineer 55 implements a solution provided by PSIR Processor 35 and executes the solution as provided. In this scenario, the Engineer 55 need only identify through some interface (e.g., graphical user interface) with PSIR Processor 35 the solution, and the PSIR Processor 35 then notifies EST Processor 40 of the solution implementation. The EST Processor 40 can then time stamp the solution implementation for tracking of its effectiveness. The Engineer 55 is also preferably provided the opportunity to provide any helpful comments that can be associated with the solution and for review by Engineers the next time the solution is provided by PSIR Processor 35.

In a second scenario, the Engineer 55 implements a solution provided by PSIR Processor 35 but changes or “tweaks” the process in some significant manner. In that scenario, the Engineer 55 identifies through an interface with PSIR Processor 35 the selected solution as well as provides detailed information on the significant changes made to the solution and an indication of any additional or eliminated materials used in the solution. PSIR Processor 35 then reports this information to EST Processor 40 for time stamping and recordation into solution database 45 as a new solution or as a subset or version of the existing solution and begins to track the efficiency of the solution.

In the third scenario, the Engineer 55 implements his or her own solution to the equipment problem. In this scenario, the Engineer 55 again reports the solution to the PSIR Processor 35 for recordation by EST Processor 40 in solution database 45 and for efficiency tracking. Being that the solution implemented by the Engineer has not been previously recorded in solution database 45, the Engineer must provide more detailed information to PSIR Processor 35 than in scenarios one and two detailing the solution process and method employed to address the equipment problem.

At step 212, the EST Processor 40 monitors the efficiency/effectiveness of the actual fix solution implemented by the Engineer (as reported to PSIR Processor 35). The details of the efficiency/effectiveness tracking process are provided below. If a new solution was implemented, the recorded actual fix solution is made available as a suggested fix solution after the solution reaches a defined efficiency rating (step 214).

As mentioned, the efficiency or effectiveness of the actual fix solution is tracked by the EST Processor 40. Once the efficiency exceeds some minimum threshold, it is flagged or otherwise identified in solution database 45 by EST Processor 40 as being available as a preferred solution. In an exemplary embodiment, solutions, therefore, can be classified as merely suggested solutions and a subset thereof as preferred solutions. Solutions may also be qualified as non-suggested or unavailable solutions if they have failed some efficiency criteria or their efficiency has not yet been tested.

An exemplary efficiency/effectiveness tracking routine is now described in connection with FIGS. 4 and 5. FIG. 4 illustrates one method of determining the efficiency of a prior solution implemented by an Engineer for a specific piece of equipment. At step 402, a solution to an equipment problem is reported by the Engineer 55 as described above in connection with FIG. 2. At step 404, it is determined whether the specific piece of equipment has previously encountered the equipment problem. This determination may be derived from maintenance records and logs of equipment problems registered with Problem Getting/Announce Processor 30. At step 406, if the equipment problem has not happened before, the system begins tracking the efficiency of the actual fix solution reported (step 402). If it is determined that the equipment problem has occurred with the piece of equipment before, the duration is calculated between when the previous solution was implemented to the equipment and when the present equipment failure occurred. At step 410, the calculated duration is compared against a standard preventative maintenance period or other expected lifetime. If the period is less than the maintenance or lifetime period, the previously implemented equipment problem solution is flagged as being inefficient or ineffective (step 414). If the period is longer than the maintenance or lifetime period, the previously implemented equipment problem solution is flagged as being an efficient or effective solution (step 412). The newly implement solution reported at 402 (which may be the same as the previous solution) is also tracked at step 406.

FIG. 5 illustrates an exemplary method of tracking and determining the efficiency of a solution identified from solution database 45 that has been previously used as an actual fix for addressing an equipment problem. At step 502, a solution from solution database 45 is identified for determination of its efficiency. This may be done periodically for all solutions in database 45 or when the EST Processor 40 is requested to recommend or otherwise provide a solution to an equipment problem. At step 504, it is determined if there have been any reoccurrences of the equipment problem at the piece of equipment at which the identified solution was implemented. If no reoccurrences have occurred, the time since implementation of the solution at the specified equipment is calculated (step 506). If there has been a reoccurrence, the time between the last implementation of the solution at the piece of equipment and the reoccurrence of the equipment problem is calculated (step 508). EST Processor 40 can identify the times at which problems have occurred from its records indicating when problems are reported to it from PSIR Processor 35 and when solutions were implemented from solution database 45. PSIR Processor 35 can optionally communicate directly with Problem Getting/Announce Processor 30.

At step 510, the calculated duration (step 506 or step 508) is compared against the mean time between or before failures (MTFB). If the time exceeds the MTFB, then the solution is flagged as an improvement solution (step 512), meaning the solution actually improves the equipment performance and is, therefore, highly efficient, effective and available. If the duration is not longer than MTFB, the duration is compared against the Preventative Maintenance Period at step 514. If the calculated duration is longer than the Preventative Maintenance Period, the solution is flagged as efficient and available at step 518. If the duration is not longer than the Preventative Maintenance Period, the solution is flagged as inefficient and unavailable (if the compared duration was calculated at step 508) or not yet efficient and unavailable (if the compared duration was calculated at step 516).

The “improvement solution”, “efficient solution” and “not yet efficient” solution flags can be used by the EST Processor 40 in making a recommendation of a solution to PSIR Processor 35. EST Processor 40 may, for example, only consider available solutions, e.g., those that are efficient or improvement solutions. The system can also make recommendations between efficient solutions, for example, by comparing the realized durations of the various solutions calculated at step 506, 508 for each solution to compare their respective efficiency. In one embodiment, a particular solution can be implemented on more than one machine of the same type, leading to respective individual efficiency ratings per implementation of the solution. The system can weight the solution based on the overall implementation of the solution, e.g., average efficiency rating or the like, in order to provide a comparative ranking of different solutions.

It should be understood that FIGS. 4 and 5 illustrate only one method of tracking the efficiency of the solutions, and other methods within the purview of those of ordinary skill in the art may be utilized.

As described above, an exemplary solution database 45 includes an identification of a plurality of equipment problems, each one of which is associated with one or more solutions. The solutions can be generated by the machine manufacturer, from actual fixes implemented by the Engineer 55 as described above, or from the knowledge and experience generally available to the equipment engineers. Each solution preferably includes a listing of necessary materials and an instruction set for implementing the solution. Solutions can be flagged to indicate their efficiency status. Data are also maintained indicating when each solution has been implemented and on which equipment, so that the efficiency of the implementation can be determined.

The above described system and methods efficiently and effectively identify equipment problems, causes and solutions while dynamically building, updating and perfecting a body of solution data for equipment problems. Equipment problems can be addressed faster and using the most reliable methods within the cumulative knowledge of the equipment manufacturers and engineers. The system and method can be used to promote standard responses to equipment problems. Further the system and method allow an engineer to familiarize himself of herself with an instruction set of a suggested solution to an equipment problem before attempting to fix the machine as well as identify the necessary materials and their availability. Still further, the efficiency and effectiveness of an implemented solution can be tracked and utilized in recommending responses to future equipment problems.

It should be apparent to one of ordinary skill that at least portions of the system (e.g., the connection between the PSIR Processor 35 and Engineer 55) may be implemented using portions of a network, such as a LAN, a WAN, or the Internet or a combination thereof. The functionality of the method may be programmed and executed by at least one computer processor unit or be distributed through several processor units, with necessary data and graphical interface pages being stored in and retrieved from one or more database storage units.

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention

1. A method of providing instructions in addressing an equipment problem comprising the following steps:
checking an indication of an equipment problem against a solution database to identify at least one suggested solution to said equipment problem;
providing a suggested solution from said at least one suggested solution for implementation; and
recording an actual fix solution implemented in association with said equipment problem.

2. The method of claim 1, further comprising the steps of:
checking said suggested solution against a materials database, said materials database including an inventory of materials needed to implement said suggested solution; and
alerting an equipment engineer of said needed materials.

3. The method of claim 2, wherein said materials database further includes an indication of availability of said materials, said method further comprising the step of alerting said equipment engineer of said availability.

4. The method of claim 1, wherein a plurality of suggested solutions are identified, said method further comprising the step of identifying a preferred solution from said plurality of suggested solutions.

5. The method of claim 4, wherein said identifying a preferred solution step includes the step of selecting said preferred solution based at least in part on an efficiency rating associated with said preferred solution.

6. The method of claim 1, further comprising the step of recording said actual fix solution into said solution database and associating said actual fix solution with said equipment problem.

7. The method of claim 6, further comprising the step of recording said actual fix solution into said solution database as a suggested solution only after said actual fix solution meets a minimum efficiency rating.

8. The method of claim 1, wherein said providing step includes the step of providing a notification to an equipment engineer, wherein said actual fix solution is implemented by said equipment engineer.

9. The method of claim 1, wherein said equipment problem is a problem associated with a piece of semiconductor fabrication equipment.

10. The method of claim 1, wherein said actual fix solution implemented in connection with said equipment problem is said provided suggested solution.

11. The method of claim 1, wherein said providing step includes the step of providing said suggested solution to a wireless device in real time.

12. A method of providing instruction in addressing an equipment problem comprising the following steps:
recording an actual fix solution implemented in association with said equipment problem;
monitoring an efficiency rating of said actual fix solution in addressing said equipment problem; and
when an efficiency rating associated with said actual fix solution exceeds a minimum efficiency rating, making said actual fix solution available as a suggested solution to said equipment problem.

13. The method of claim 12, further comprising the steps of:
checking a received indication of an equipment problem against a solution database to identify at least one suggested solution to said received equipment problem; and
providing a suggested solution from said at least one suggested solution to an equipment engineer.

14. The method of claim 13, wherein said making step includes the step of recording said actual fix solution in said solution database.

15. The method of claim 13, further comprising the step of associating said actual fix solution with materials used in said actual fix solution.

16. The method of claim 15, further comprising the steps of:
checking said suggested solution against a materials database, said materials database including an inventory of materials needed to implement said suggested solution; and
alerting said equipment engineer of said needed materials.

17. The method of claim 16, wherein said materials database further includes an indication of availability of said materials, said method further comprising the step of alerting said equipment engineer of said availability.

18. The method of claim 12, wherein a plurality of suggested solutions are identified, said method further comprising the steps of identifying a preferred solution from said plurality of suggested solutions.

19. The method of claim 18, wherein said identifying a preferred solution step includes the step of selecting said preferred solution based at least in part on an efficiency rating associated with said preferred solution.

20. The method of claim 12, wherein said equipment problem is a problem associated with a piece of semiconductor fabrication equipment.

21. A system for providing instructions in addressing an equipment problem comprising:
means for checking an indication of an equipment problem against a solution database to identify at least one suggested solution to said equipment problem;
means for providing a suggested solution from said at least one suggested solution for implementation; and
means for recording an actual fix solution implemented in associated with said equipment problem.

22. The system of claim 21, further comprising:
means for checking said suggested solution against a materials database, said materials database including an inventory of materials needed to implement said suggested solution; and
means for alerting an equipment engineer of said needed materials.

23. The system of 22, wherein said materials database further includes an indication of availability of said materials, said system further comprising means for alerting said equipment engineer of said availability.

24. The system of claim 21, wherein a plurality of suggested solutions are identified, said system further comprising means for identifying a preferred solution from said plurality of suggested solutions.

25. The system of claim 24, wherein said identifying a preferred solution means includes means for selecting said preferred solution based at least in part on an efficiency rating associated with said preferred solution.

26. The system of claim 21, further comprising means for recording said actual fix solution into said solution database and associating said actual fix solution with said equipment problem.

27. The system of claim 26, wherein said actual fix is recorded into said solution database as a suggested solution only after said actual fix solution meets a minimum efficiency rating.

28. The system of claim 21, wherein said providing means includes means for providing a notification to an equipment engineer, wherein said actual fix solution is implemented by said equipment engineer.

29. The system of claim 21, wherein said equipment problem is a problem associated with a piece of semiconductor fabrication equipment.

30. The system of claim 21, wherein said actual fix solution implemented in connection with said equipment problem is said provided suggested solution.

31. The system of claim 21, wherein said providing means includes means for providing said suggested solution to a wireless device in real time.

32. A system for providing instruction in addressing an equipment problem comprising:
means for recording an actual fix solution implemented in association with said equipment problem;
means for monitoring an efficiency rating of said actual fix solution in addressing said equipment problem; and
means for making said actual fix solution available as a suggested solution to said equipment problem when an efficiency rating associated with said actual fix solution exceeds a minimum efficiency rating.

33. The system of claim 32, further comprising:
means for checking a received indication of an equipment problem against a solution database to identify at least one suggested solution to said received equipment problem; and
means for providing a suggested solution from said at least one suggested solution to an equipment engineer.

34. The system of claim 33, wherein said making means includes means for recording said actual fix solution in said solution database.

35. The system of claim 33, further comprising means for associating said actual fix solution with materials used in said actual fix solution.

36. The system of method of claim 35, further comprising:
means for checking said suggested solution against a materials database, said materials database including an inventory of materials needed to implement said suggested solution; and
means for alerting said equipment engineer of said needed materials.

37. The system of claim 35, wherein said materials database further includes an indication of availability of said materials, said system further comprising means for alerting said equipment engineer of said availability.

38. The system of claim 32, wherein a plurality of suggested solutions are identified, said system further comprising means for identifying a preferred solution from said plurality of suggested solutions.

39. The system of claim 38, wherein said identifying a preferred solution means includes means for selecting said preferred solution based at least in part on an efficiency rating associated with said preferred solution.

40. The system of claim 30, wherein said equipment problem is a problem associated with a piece of semiconductor fabrication equipment.
